(19) United States
(12) Patent Application Publication
(10) Pub. No.: US 2026/0194910 A1
(43) Pub. Date: Jul. 9, 2026

(54) INFORMATION PROCESSING APPARATUS, INFORMATION PROCESSING METHOD, INFORMATION PROCESSING SYSTEM, AND REMOTE ASSISTANCE SERVER

(71) Applicant: SONY GROUP CORPORATION, Tokyo (JP)

(72) Inventor: Junji KATO, Tokyo (JP)

(21) Appl. No.: 19/128,175

(22) PCT Filed: Oct. 19, 2023
(86) PCT No.: PCT/JP2023/037838

§ 371 Date: May 8, 2025

(30) Foreign Application Priority Data
Nov. 15, 2022 (JP) 2022-182374

(51) Int. Cl. G05D 1/622; G05D 1/227; G05D 107/13; G05D 109/10

(52) U.S. Cl. CPC G05D 1/622; G05D 1/227; G05D 2107/13; G05D 2109/10

(57) ABSTRACT

To safely guide a remote driving vehicle and reduce load on a remote driving operator. A road surface environment information generation unit and a control information generation unit are provided. The road surface environment information generation unit generates road surface environment information on a road surface of a predetermined route on the basis of a vehicle operation state when a first vehicle travels on the predetermined route. The control information generation unit generates control information when a second vehicle travels on the predetermined route on the basis of the road surface environment information. For example, the predetermined route is a route on which the first vehicle travels when the first vehicle avoids a predetermined obstacle.

### TECHNICAL FIELD

The present technology relates to an information processing apparatus, an information processing method, an information processing system, and a remote assistance server, and more particularly to an information processing apparatus, and the like, capable of reducing load on a remote driving operator.

### BACKGROUND ART

There has been proposed a method for providing remote driving assistance from a remote driving operator remote from an automated vehicle in order for the automated vehicle to pass therethrough in a scene where the automated vehicle encounters an obstacle due to which the automated vehicle cannot execute automated driving. For example, as the obstacle due to which automated driving cannot be executed, a road obstacle (a step, a depression, discrepancy from map information, or the like) and a temporary obstacle at the time of observation (road construction, parked vehicle, travel regulation, accident, or the like) can be considered.

The automated vehicle having encountered such an obstacle transmits a request for remote driving to the remote driving operator. The remote driving operator who has received the request for remote driving checks a surrounding situation of the automated vehicle such as a video from a camera transmitted from the automated vehicle on a remote monitor, grasps the situation, determines a driving assistance method, and performs driving assistance for the automated vehicle.

Generally, in such a case, it is conceivable that the number of automated vehicles that require assistance is not limited to one, and remote driving assistance is required for a plurality of automated vehicles. In a case where remote driving is requested from a plurality of automated vehicles, it is necessary for one remote driving operator to perform remote driving assistance corresponding to the number of automated vehicles, or for a plurality of remote driving operators to share remote driving assistance corresponding to the number of automated vehicles. In either case, the load on the remote driving operators increases.

For example, Patent Document 1 proposes a technology for controlling a vehicle by calculating a traveling track of another vehicle traveling around the own vehicle, and generating assistance route candidates for moving the own vehicle on the basis of the traveling track.

However, this technology considers only route information, and there is a case where safe and secure driving cannot be provided only by the route information. For example, in a case where the route through which the vehicle passes is not a smooth and flat road, for example, in a case where there is a step or a depression of several cm, there is a case where an impact is transmitted to a passenger of the vehicle by passing through the step or the depression without adjusting the speed, and dangerous driving is performed.

### CITATION LIST

### Patent Document

Patent Document 1: Japanese Patent Application Laid-Open No. 2019-185293

### SUMMARY OF THE INVENTION

### Problems to be Solved by the Invention

An object of the present technology is to safely guide a remote driving vehicle and reduce load on a remote driving operator.

### Solutions to Problems

Concept of the present technology is in an information processing apparatus including:
a road surface environment information generation unit that generates road surface environment information on a road surface of a predetermined route on the basis of a vehicle operation state when a first vehicle travels on the predetermined route; and
a control information generation unit that generates control information when a second vehicle travels on the predetermined route on the basis of the road surface environment information.

The present technology includes a road surface environment information generation unit and a control information generation unit. The road surface environment information generation unit generates the road surface environment information on the road surface of the predetermined route on the basis of the vehicle operation state when the first vehicle travels on the predetermined route. Then, the control information generation unit generates the control information when the second vehicle travels on the predetermined route on the basis of the road surface environment information.

For example, the predetermined route may be a route on which the first vehicle travels when the first vehicle avoids a predetermined obstacle. In this case, for example, the predetermined obstacle may exist on the predetermined route. Furthermore, in this case, for example, the predetermined obstacle may exist on a route different from the predetermined route, and the predetermined route may be a route for bypassing the route different from the predetermined route.

Furthermore, for example, the information processing apparatus may further include a storage unit that records the road surface environment information generated by the road surface environment information generation unit in association with position information and expiration period information. In this case, for example, the control information generation unit may selectively use the road surface environment information corresponding to the predetermined route on the basis of the position information. In this case, for example, the control information generation unit may selectively use the road surface environment information within an expiration period on the basis of the expiration period information.

Furthermore, in this case, for example, the information processing apparatus may further include a road surface environment information update unit that generates road surface environment information on the basis of vehicle operation information when the second vehicle travels on the predetermined route and updates the road surface environment information recorded in the storage unit. Here, for example, the road surface environment information update unit may record the generated road surface environment information in the storage unit when the road surface environment information for the same position as the generated road surface environment information is not recorded in the storage unit.

Here, for example, the road surface environment information update unit may extend an expiration period of the recorded road surface environment information when the road surface environment information having the same content for the same position as the generated road surface environment information is recorded in the storage unit. Here, for example, the road surface environment information update unit may delete the recorded road surface environment information from the storage unit and record the generated road surface environment information in the storage unit when the road surface environment information having different content for the same position as the generated road surface environment information is recorded in the storage unit.

Here, for example, the information processing apparatus may further include a road surface environment information update notification unit that, when the road surface environment information recorded in the storage unit is updated by the road surface environment information update unit, notifies a remote driving operator of the update.

As described above, in the present technology, the road surface environment information on the road surface of the predetermined route is generated on the basis of the vehicle operation state when the first vehicle travels on the predetermined route, and the control information when the second vehicle travels on the predetermined route is generated on the basis of the road surface environment information, so that it is possible to safely guide the remote driving vehicle (second vehicle) and reduce load on the remote driving operator.

Furthermore, another concept of the present technology is an information processing method including:
a procedure of generating road surface environment information on a road surface of a predetermined route on the basis of a vehicle operation state when a first vehicle travels on the predetermined route; and
a procedure of generating control information when a second vehicle travels on the predetermined route on the basis of the road surface environment information.

Another concept of the present technology is an information processing system including:
a first vehicle;
a remote assistance server; and
a second vehicle, in which
the first vehicle transmits vehicle operation information when the first vehicle travels on a predetermined route to the remote assistance server,
the remote assistance server generates road surface environment information on a road surface of the predetermined route on the basis of the vehicle operation information transmitted from the first vehicle, and transmits the generated road surface environment information or control information generated on the basis of the road surface environment information to the second vehicle traveling on the predetermined route, and
the second vehicle performs automated driving control on the basis of control information generated on the basis of the road surface environment information transmitted from the remote assistance server or the control information transmitted from the remote assistance server.

The present technology includes the first vehicle, the remote assistance server, and the second vehicle. Then, the first vehicle transmits vehicle operation information at the time of traveling on the predetermined route to the remote assistance server. In addition, the road surface environment information on the road surface of the predetermined route is generated by the remote assistance server on the basis of the vehicle operation information transmitted from the first vehicle, and the generated road surface environment information or the control information generated on the basis of the road surface environment information is transmitted to the second vehicle traveling on the predetermined route. In addition, the second vehicle performs the automated driving control on the basis of the control information generated on the basis of the road surface environment information transmitted from the remote assistance server or the control information transmitted from the remote assistance server.

For example, the first vehicle may travel on the predetermined route on the basis of operation by a remote driving operator. Furthermore, for example, the predetermined route may be a route on which the first vehicle travels when the first vehicle avoids a predetermined obstacle. In this case, for example, the predetermined obstacle may exist on the predetermined route. In this case, for example, the predetermined obstacle may exist on a route different from the predetermined route, and the predetermined route may be a route for bypassing the route different from the predetermined route.

As described above, in the present technology, the first vehicle transmits the vehicle operation information when the first vehicle travels on the predetermined route to the remote assistance server, the remote assistance server generates the road surface environment information on the road surface of the predetermined route on the basis of the vehicle operation information transmitted from the first vehicle, and transmits the generated road surface environment information or the control information generated on the basis of the road surface environment information to the second vehicle traveling on the predetermined route, and the second vehicle performs automated driving control on the basis of the control information generated on the basis of the road surface environment information transmitted from the remote assistance server or the control information transmitted from the remote assistance server, so that it is possible to safely guide the remote driving vehicle (second vehicle) and reduce the load on the remote driving operator.

Furthermore, another concept of the present technology is in a driving assistance server including:
a reception unit that receives a vehicle operation state when a first vehicle travels on a predetermined route from the first vehicle;
a generation unit that generates road surface environment information on a road surface of the predetermined route on the basis of the vehicle operation state; and
a transmission unit that transmits the road surface environment information or control information generated on the basis of the road surface environment information to a second vehicle traveling on the predetermined route.

The present technology includes the reception unit, the generation unit, and the transmission unit. Then, the reception unit receives the vehicle operation state when the first vehicle travels on the predetermined route. In addition, the generation unit generates the road surface environment information on the road surface of the predetermined route on the basis of the vehicle operation state. The transmission unit transmits the road surface environment information or the control information generated on the basis of the road surface environment information to the second vehicle traveling on the predetermined route.

For example, the driving assistance server may further include a storage unit that records the road surface environment information generated by the generation unit in association with position information and expiration period information.

As described above, in the present technology, the vehicle operation state when the first vehicle travels on the predetermined route is received from the first vehicle, the road surface environment information on the road surface of the predetermined route is generated on the basis of the vehicle operation state, and the road surface environment information or the control information generated on the basis of the road surface environment information is transmitted to the second vehicle traveling on the predetermined route, so that it is possible to safely guide the remote driving vehicle (second vehicle) and reduce the load on the remote driving operator.

### BRIEF DESCRIPTION OF DRAWINGS

FIG. 1 is a view illustrating a configuration example of a remote driving system as an embodiment.

FIG. 2 is a view illustrating a configuration example of a remote driving controller.

FIG. 3 is a block diagram illustrating an example of an internal configuration of the remote driving controller.

FIG. 4 is a block diagram illustrating an example of a device configuration of the remote driving controller.

FIG. 5 is a block diagram illustrating an example of an internal configuration of a vehicle.

FIG. 6 is a block diagram illustrating an example of a device configuration of the vehicle.

FIG. 7 is a block diagram illustrating an example of an internal configuration of a remote assistance server.

FIG. 8 is a view illustrating an example of setting of an expiration period of road surface environment information.

FIG. 9 is a view illustrating an example of road surface environment information held in a storage unit.

FIG. 10 is a block diagram illustrating an example of a device configuration of the remote assistance server.

FIG. 11 is a flowchart indicating an example of an overall processing procedure of the remote driving system when the remote assistance server receives a remote assistance request transmitted from the vehicle.

FIG. 12 is a flowchart indicating an example of a processing procedure of update processing of the road surface environment information.

FIG. 13 is a view indicating an example of an overall sequence of a remote assistance system in a case where the remote assistance server issues a remote driving operator assignment request to the remote driving controller to cause the remote driving controller to execute remote driving of the vehicle.

FIG. 14 is a view indicating an example of an overall sequence of the remote assistance system in a case where the remote assistance server transmits route information and road surface environment information as driving assistance information to the vehicle to cause the vehicle to execute automated driving.

### MODE FOR CARRYING OUT THE INVENTION

Hereinafter, a mode for carrying out the invention (hereinafter, referred to as an “embodiment”) will be described. Note that the description will be made in the following order.
1. Embodiment
2. Modifications

### 1. Embodiment

### (Configuration Example of Remote Driving System)

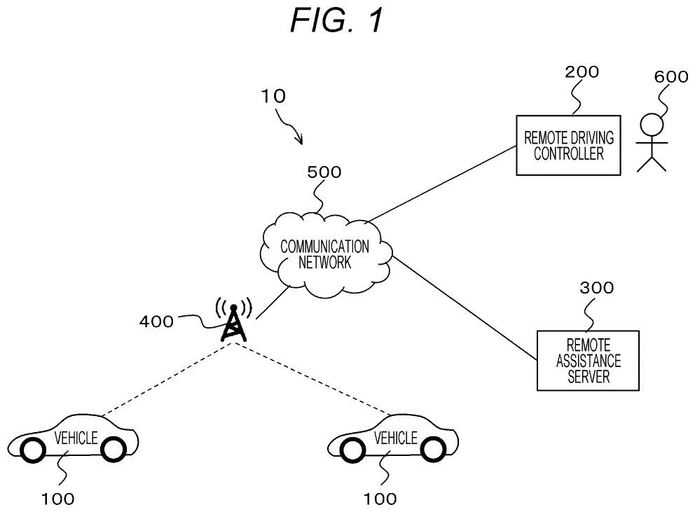

FIG. 1 illustrates a configuration example of a remote driving system 10 as an embodiment. The remote driving system 10 includes a vehicle 100, a remote driving controller 200, a remote assistance server 300, a wireless base station 400, and a communication network 500.

The vehicle 100 constitutes a remote driving vehicle for which driving is to be remotely assisted. In the illustrated example, two vehicles 100 are illustrated, but the number of vehicles 100 is not limited to two. The remote driving controller 200 is operated by a human remote driving operator 600.

The remote assistance server 300 receives a remote assistance request from the vehicle 100 and provides and manages a driving assistance service. The wireless base station 400 performs wireless communication with the vehicle 100 by long term evolution (LTE), 5th generation (5G), or the like. The communication network 500 performs communication among the wireless base station 400, the remote driving controller 200, and the remote assistance server 300.

In the remote driving system 10, a case where the remote driving service is provided by the remote driving operator 600 and a case where the remote assistance service is mechanically provided by the remote assistance server 300 are assumed.

In a case where the remote driving service is provided by the remote driving operator 600, it is assumed that the remote driving controller 200 and the vehicle 100 exchange video data, status information, and a driving control command (steering wheel steering information, accelerator/brake operation information, or the like) via communication to implement remote driving of the vehicle 100 (direct control).

In a case where the remote assistance server 300 mechanically provides the remote assistance service, it is assumed that the remote assistance server 300 calculates route information and road surface environment information and transmits the information to the vehicle 100, and the driving control is autonomously performed on the vehicle 100 side on the basis of the information (indirect control).

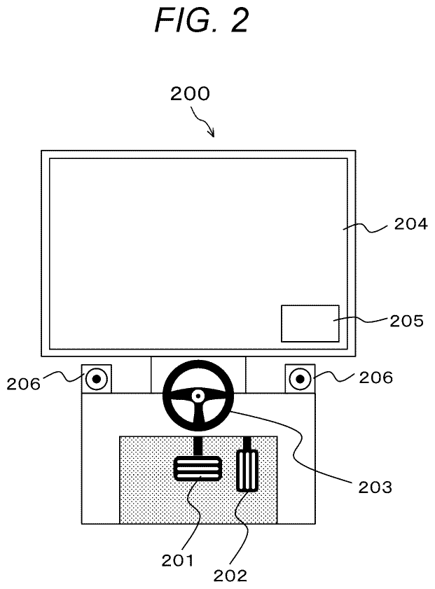

FIG. 2 illustrates a configuration example of the remote driving controller 200. The remote driving controller 200 assumes that the remote driving operator 600 operates a steering wheel, a brake pedal, an accelerator pedal, and the like, on the basis of a video from a camera and sound from a microphone transmitted from the vehicle 100.

The remote driving controller 200 includes a brake pedal 201, an accelerator pedal 202, a steering wheel 203, a video display device 204, a status display area 205, and a speaker 206. The video display device 204 includes a liquid crystal display, an organic electro luminescence (EL) display, and the like. The status display area 205 includes part of a display area of the video display device 204.

Acceleration/deceleration amounts of the brake pedal 201 and the accelerator pedal 202 and a steering amount of the steering wheel 203 operated by the remote driving operator 600 are transmitted to the vehicle 100 via communication. In addition, a video from a camera is displayed on the video display device 204 on the basis of video data received from the vehicle 100 via communication. In addition, sound from a microphone is output from the speaker 206 on the basis of sound data received from the vehicle 100 via communication. Furthermore, a status of the vehicle 100 is displayed in the status display area 205 on the basis of the status information received from the vehicle 100 via communication.

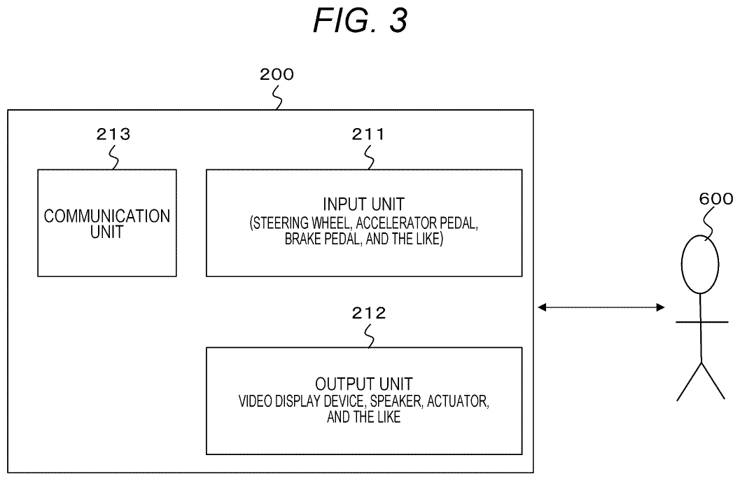

FIG. 3 illustrates an example of an internal configuration of the remote driving controller 200. The remote driving controller 200 includes an input unit 211, an output unit 212, and a communication unit 213. The input unit 211 acquires operation information of the remote driving operator 600 using the brake pedal 201, the accelerator pedal 202, and the steering wheel 203 (see FIG. 2), and transmits the operation information to the communication unit 213.

The output unit 212 displays the video from the camera and the status of the vehicle 100 in the display area and the status display area 205 of the video display device 204 on the basis of the video data and the status information acquired from the communication unit 213. In addition, the output unit 212 outputs the sound from the microphone of the vehicle 100 from the speaker 206 on the basis of the sound data acquired from the communication unit 213. Further, although not described above, the output unit 212 drives an actuator on the basis of vibration information acquired from the communication unit 213 to vibrate a seat of the remote driving operator 600 to reproduce vibration of the vehicle 100.

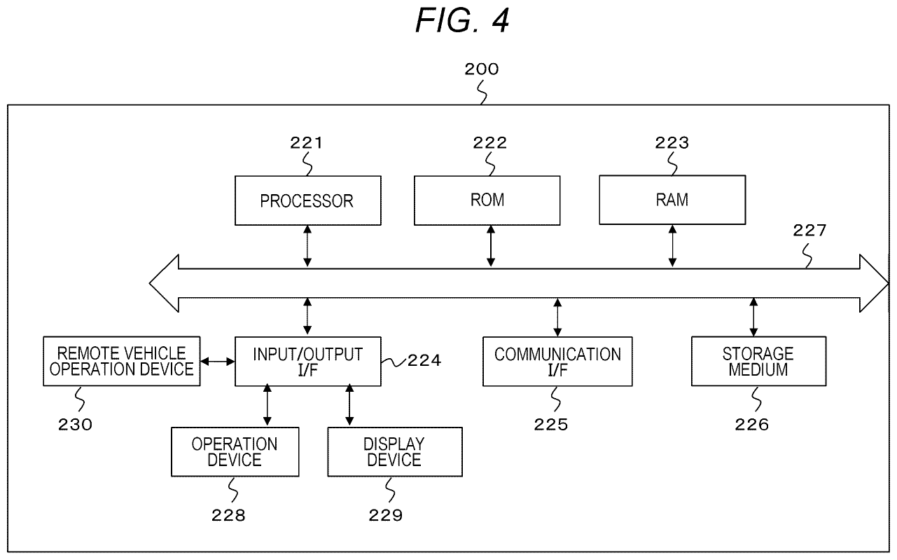

FIG. 4 illustrates an example of a device configuration of the remote driving controller 200. The remote driving controller 200 has a configuration in which a processor 221, a ROM 222, a RAM 223, an input/output interface 224, a communication interface 225, and a storage medium 226 are connected to a bus 227. An operation device 228, a display device 229, and a remote vehicle operation device 230 are connected to the input/output interface 224. Here, the remote vehicle operation device 230 is a steering wheel, a brake pedal, an accelerator pedal, or the like.

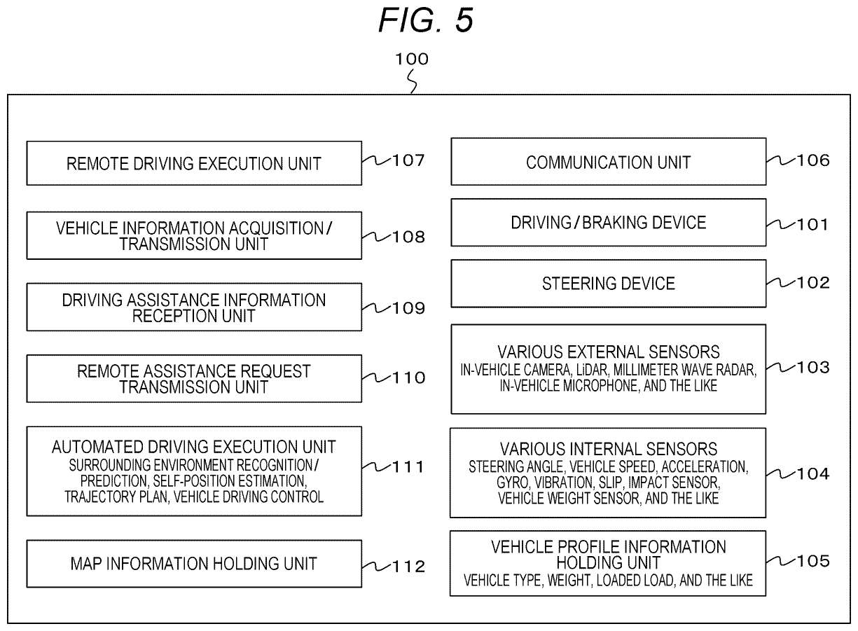

FIG. 5 illustrates an example of an internal configuration of the vehicle 100. The vehicle 100 includes a driving/braking device 101, a steering device 102, various external sensors 103, various internal sensors 104, a vehicle profile information holding unit 105, a communication unit 106, a remote driving execution unit 107, a vehicle information acquisition/transmission unit 108, a driving assistance information reception unit 109, a remote assistance request transmission unit 110, an automated driving execution unit 111, and a map information holding unit 112.

The various external sensors 103 are sensors for recognizing a surrounding environment of the vehicle 100, and include at least one or more sensors among an in-vehicle camera, a light detection and ranging (LiDAR), a millimeter wave radar, an in-vehicle microphone, and the like. The various internal sensors 104 are sensors for detecting an internal state and a traveling state of the vehicle 100, and include at least one or more sensors among a steering angle, a vehicle speed, an acceleration, a gyro, a vibration, a slip, an impact sensor, a vehicle weight sensor, and the like.

The vehicle profile holding unit 105 has at least one or more pieces of information among information such as a vehicle type, a vehicle weight, and a loaded load. The communication unit 106 communicates with the remote driving controller 200 and the remote assistance server 300 via the communication network 500.

The remote driving execution unit 107 receives a control command (an acceleration/deceleration amount, a steering amount, or the like) from the remote driving controller 200 via the communication unit 106 and executes remote driving. In this event, the remote driving execution unit 107 controls the driving/braking device 101 and the steering device 102 on the basis of the control command (an acceleration/deceleration amount, a steering amount, or the like). Furthermore, in this event, information around the vehicle 100 acquired by the various external sensors 103 and the internal state and traveling state of the vehicle 100 acquired by the various internal sensors 104 are transmitted to the remote driving controller 200 via the communication unit 106. For example, video data around the vehicle 100 captured by the in-vehicle camera, status information such as a speed, an acceleration, and a steering angle of the vehicle 100, and the like, are transmitted.

The vehicle information acquisition/transmission unit 108 acquires at least one of the information (a speed, an acceleration, a jerk, a gyro, vibration, slip information, and the like) indicating an operation state of the vehicle acquired by the various internal sensors 104, and repeatedly transmits the information to the remote assistance server 300 via the communication unit 106. In this case, position information and vehicle profile information are also transmitted together with the information indicating the operation state of the vehicle.

The information indicating the operation state of the vehicle, the position information, and the vehicle profile information constitute vehicle information. Note that the vehicle profile information is static information, and it is not necessary to include the vehicle profile information in the vehicle information every time.

Furthermore, in this case, at least one of the information regarding the surrounding environment of the vehicle 100 (information obtained by an in-vehicle camera, a LiDAR, a millimeter wave radar, an in-vehicle microphone, and the like) acquired by the various external sensors 103 may be further transmitted as the operation state of the vehicle. In the present embodiment, it is assumed that information regarding the surrounding environment of the vehicle 100 acquired by the various external sensors 103 is also transmitted as the operation state of the vehicle.

The remote assistance information reception unit 109 receives the driving assistance information (route information, road surface environment information, and the like) transmitted from the remote assistance server 300 via the communication unit 106. Then, the remote assistance information reception unit 109 notifies the automated driving execution unit 111 of the received driving assistance information. In a case where the automated driving execution unit 111 determines that autonomous automated driving cannot be executed, the remote assistance request transmission unit 110 transmits a driving assistance request to the remote assistance server 300 via the communication unit 106.

The automated driving execution unit 111 controls the driving/braking device 101 and the steering device 102 on the basis of map information (information such as lanes through which the vehicle can pass and road signs) held in the map information holding unit 112 and further information input from the various external sensors 103 and the various internal sensors 104, and executes autonomous automated driving of the vehicle 100. In a case where the remote assistance information reception unit 109 receives the driving assistance information (route information, road surface environment information, and the like) transmitted from the remote assistance server 300, the automated driving execution unit 111 generates control information (control information of the acceleration/deceleration amount, the steering amount, and the like) for safely passing through the route indicated by the route information on the basis of the road surface environment information and the vehicle profile information, and controls traveling on the route indicated by the route information on the basis of the control information.

In a case where the vehicle 100 encounters an obstacle due to which the automated driving cannot be executed and cannot execute automated driving, the automated driving execution unit 111 requests the remote assistance request from the remote assistance request transmission unit 110. As described above, examples of the obstacle due to which the vehicle 100 cannot execute automated driving include a road obstacle (a step, a depression, discrepancy from map information, or the like) and a temporary obstacle at the time of observation (road construction, a parked vehicle, travel regulation, an accident, or the like). Here, the discrepancy from the map information means a case where the surrounding environment acquired by the vehicle 100 is different from the held map information. In addition, in a case of road construction, a parked vehicle, travel regulation, an accident, or the like, there may be a case where the vehicle cannot travel unless the vehicle strays onto another lane when avoiding the obstacle.

For example, in a case of a road obstacle, when the vehicle 100 avoids the obstacle, it is conceivable that the vehicle 100 travels on a route where the obstacle exists or travels on a route that bypasses the route where the obstacle exists (including a case where the vehicle strays onto another lane). Furthermore, for example, in a case of a temporary obstacle at the time of observation, when the vehicle 100 avoids the obstacle, it is conceivable that the vehicle 100 travels on a route that bypasses the route where the obstacle exists (including a case where the vehicle strays onto another lane). In this case, it is also conceivable that there may be a bad road factor such as a step, a depression, or slipperiness in the route that bypasses the route. For example, in a case of road construction, a plate for hiding an electric cable is disposed on the route that bypasses the route, or the route that bypasses the route is an unpaved gravel road.

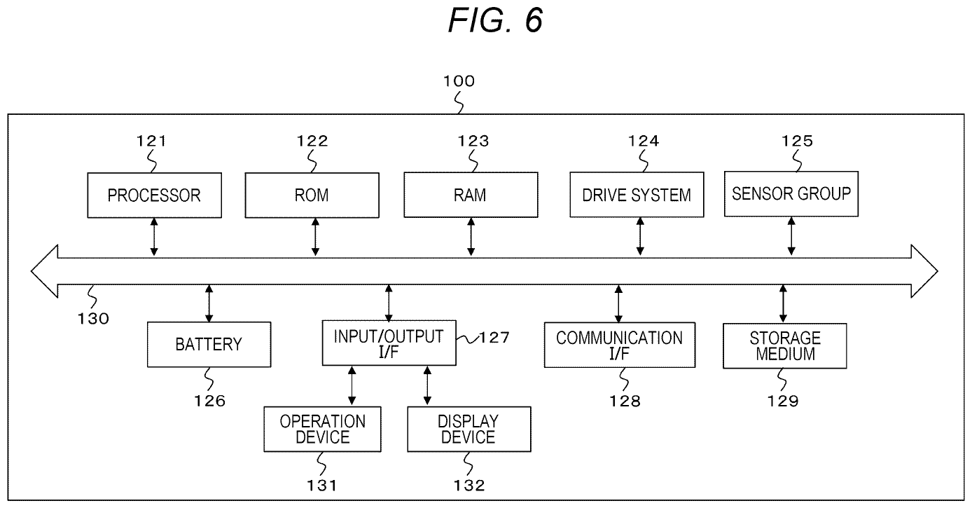

FIG. 6 illustrates an example of a device configuration of the vehicle 100. This example assumes an electric vehicle. The vehicle 100 has a configuration in which a processor 121, a ROM 122, a RAM 123, a drive system 124, a sensor group 125, a battery 126, an input/output interface 127, a communication interface 128, and a storage medium 129 are connected to a bus 130. An operation device 131 and a display device 132 are connected to the input/output interface 127. Here, the sensor group 125 includes various external sensors and various internal sensors.

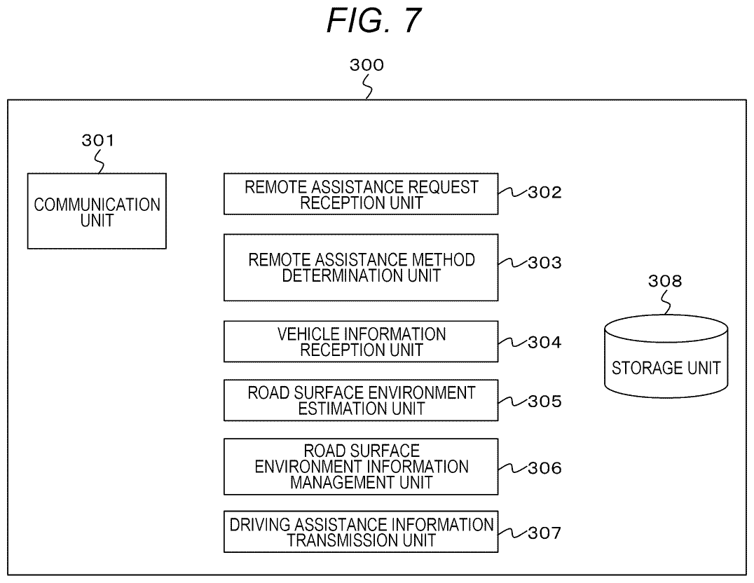

FIG. 7 illustrates an example of an internal configuration of the remote assistance server 300. The remote assistance server 300 includes a communication unit 301, a remote assistance request reception unit 302, a remote assistance method determination unit 303, a vehicle information reception unit 304, a road surface environment estimation unit 305, a road surface environment information management unit 306, a driving assistance information transmission unit 307, and a storage unit 308.

The communication unit 301 communicates with the vehicle 100 and the remote driving controller 200 via the communication network 500. The remote assistance request reception unit 302 receives the remote assistance request transmitted from the vehicle 100 via the communication unit 301.

Upon receiving the notification indicating that the remote assistance request is received from the remote assistance request reception unit 302, the remote assistance method determination unit 303 determines whether to provide a remote driving service by the remote driving operator 600 or to mechanically provide a remote assistance service by the remote assistance server 300. For example, the remote assistance method determination unit 303 confirms whether or not past route information at the time of avoiding an obstacle that can be analogized to the same obstacle as this time (obstacle due to which automated driving cannot be executed) exists in the storage unit 308. If there is past route information, the remote assistance method determination unit determines to mechanically provide the remote assistance service, and if there is no route information, the remote assistance method determination unit determines to provide the remote driving service by the remote driving operator 600.

The vehicle information reception unit 304 receives vehicle information (information indicating the operation state of the vehicle, the position information and the vehicle profile information) transmitted from the vehicle 100 via the communication unit 301. Note that as described above, the information indicating the operation state of the vehicle includes not only the information acquired by the various internal sensors 104 (a speed, an acceleration, a jerk, a gyro, vibration, slip information, and the like) but also environment information around the vehicle (information obtained by an in-vehicle camera, a LiDAR, a millimeter wave radar, an in-vehicle microphone, or the like) acquired by the various external sensors 103.

The road surface environment estimation unit 305 estimates a feature of the road surface, for example, a step, a depression, slipperiness, and the like, from the information (a vehicle speed, an acceleration, a jerk, vibration, slip, and the like) indicating the operation state of the vehicle received by the vehicle information reception unit 304, and estimates road surface environment information which is feature information of the road surface in a form independent of the vehicle type from the feature information of the road surface and the vehicle profile information (information regarding a vehicle type, a vehicle weight, a loaded load, and the like). The road surface environment information in this case is information regarding a bad road factor such as a step, a depression, and a friction coefficient. For example, the road surface environment information is information such as a step of 5 cm, a depression of 10 cm, and a friction coefficient of 0.5.

In addition, the road surface environment estimation unit 305 determines, from the road surface environment information, whether the road surface environment is a bad road that impairs ride comfort. Then, in a case where it is determined that the road surface environment is a bad road that impairs ride comfort, the road surface environment estimation unit 305 notifies the road surface information management unit 306 of the road surface environment information.

Here, in the determination as to whether or not the road surface environment is a bad road, for example, in a case where a vehicle having a certain weight passes through a road surface with a step or a depression indicated by the road surface environment information at a certain speed, it is estimated how much the jerk changes, and in a case where the jerk exceeds a certain threshold, it is determined that the road surface environment is a bad road that impairs ride comfort. Note that the method for determining whether or not the road surface environment is a bad road is not limited thereto.

The road surface environment information management unit 306 compares the road surface environment information notified from the road surface environment estimation unit 305 with the road surface environment information recorded in the storage unit 308, and updates the expiration period of the recorded road surface environment information, invalidates the recorded road surface environment information, or sets and records the expiration period of new road surface environment information. The storage unit 308 holds route information when an obstacle has been avoided in the past and road surface environment information associated with the route information.

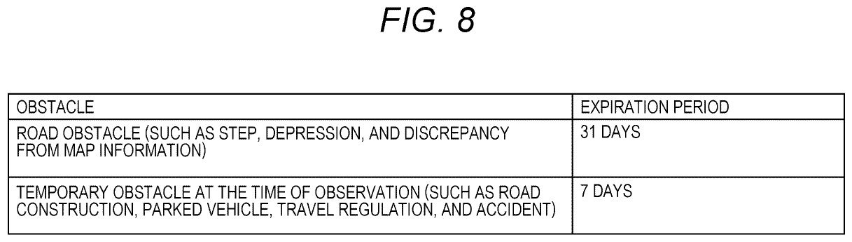

FIG. 8 illustrates an example of setting of the expiration period of the road surface environment information. For example, in a case where the road surface environment information relates to a road obstacle (a step, a depression, discrepancy from map information, or the like), the expiration period is set to 31 days (one month), and in a case where the road surface environment information relates to a temporary obstacle at the time of observation (road construction, a parked vehicle, travel regulation, an accident, or the like), the expiration period is set to 7 days (one week). In this case, in a case where the obstacle is a temporary obstacle at the time of observation, there is a high possibility that the obstacle is removed relatively quickly. Thus, by setting the expiration period to be short, it is possible to prevent unnecessary road surface environment information from being held in the storage unit 308 for a long time. Note that the expiration period of the road surface environment information is defined as, for example, a day on which the expiration period has elapsed from the day on which the road surface environment information is detected.

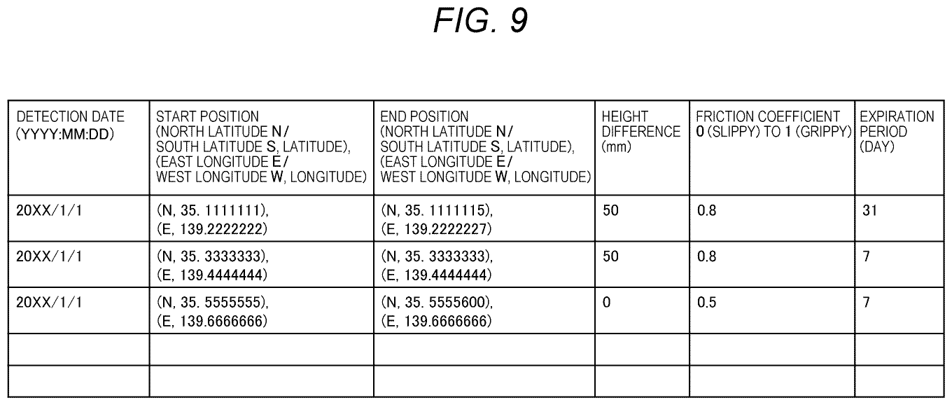

FIG. 9 illustrates an example of the road surface environment information held in storage unit 308. Here, “detection date” indicates date on which the road surface environment information has been detected. Further a “start position” and an “end position” indicate positions where the road surface environment information is detected in the route when the obstacle is avoided. A “height difference” and a “friction coefficient” indicate an example of the detected road surface environment information.

Upon receiving a request for driving assistance from the remote assistance method determination unit 303, the driving assistance information transmission unit 307 reads the route information and the road surface environment information associated with the route and within the expiration period from the storage unit 308, and transmits the route information and the road surface environment information to the vehicle 100 via the communication unit 301. Alternatively, the driving assistance information transmission unit 307 may generate control information (control information of an acceleration/deceleration amount, a steering amount, and the like) for safely passing on the basis of the road surface environment information and the vehicle profile information, and transmit the control information together with the route information to the vehicle 100 via the communication unit 301. Here, the information regarding the acceleration/deceleration amount can be expressed by, for example, position information and vehicle speed information for passing through the position.

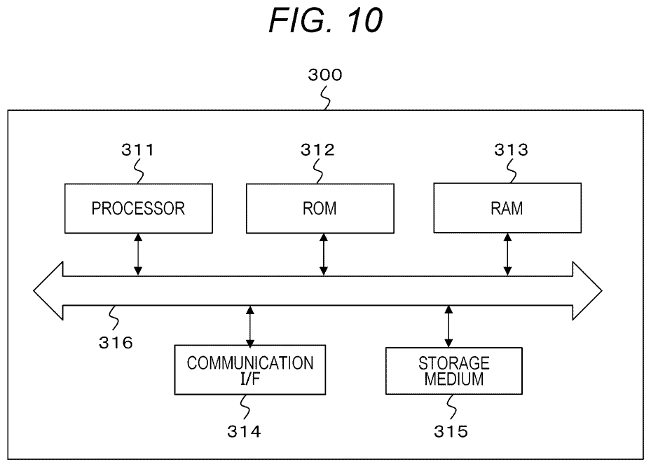

FIG. 10 illustrates an example of a device configuration of the remote assistance server 300. The remote assistance server 300 has a configuration in which a processor 311, a ROM 312, a RAM 313, a communication interface 314, and a storage medium 315 are connected to a bus 316.

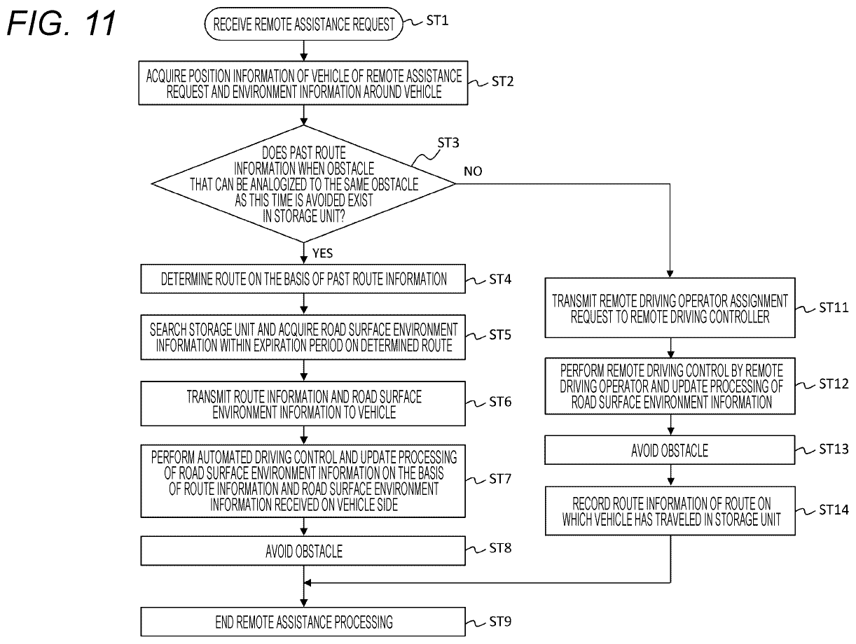

The flowchart of FIG. 11 indicates an example of the entire processing procedure of the remote driving system 10 when the remote assistance request reception unit 302 of the remote assistance server 300 receives the remote assistance request transmitted from the vehicle 100 via the communication unit 301.

In step ST1, the remote assistance request reception unit 302 of the remote assistance server 300 receives the remote assistance request from the vehicle 100, whereby the processing is started.

Next, in step ST2, the remote assistance method determination unit 303 of the remote assistance server 300 acquires the position information of the vehicle 100 that has transmitted the remote assistance request and the environment information around the vehicle from the vehicle information received from the vehicle 100 by the vehicle information reception unit 304.

Next, in step ST3, the remote assistance method determination unit 303 of the remote assistance server 300 determines whether or not past route information when an obstacle that can be analogized to the same obstacle as this time (obstacle due to which automated driving cannot be executed) is avoided exists in the storage unit 308 on the basis of the position information of the vehicle 100 that has transmitted the remote assistance request acquired in step ST2 and the environment information around the vehicle.

In a case where it is determined that the past route information exists, the remote assistance method determination unit 303 of the remote assistance server 300 calculates and determines the route of the vehicle 100 that has transmitted the remote assistance request on the basis of the past route information in step ST4.

Next, in step ST5, the remote assistance method determination unit 303 of the remote assistance server 300 searches the storage unit 308 to acquire the road surface environment information within the expiration period on the determined route. In this case, the road surface environment information within the expiration period on the determined route does not necessarily exist in the storage unit 308, and may not exist.

Next, in step ST6, the remote assistance method determination unit 303 of the remote assistance server 300 transmits, as driving assistance information, the route information determined in step ST4 and the road surface environment information acquired in step ST5 to the vehicle 100 that has transmitted the remote assistance request via the communication unit 301. As described above, in a case where the road surface environment information corresponding to the route information does not exist, only the route information is transmitted.

Next, in step ST7, the automated driving execution unit 111 of the vehicle 100 that has transmitted the remote assistance request performs automated driving control on the basis of the route information and the road surface environment information received by the driving assistance information reception unit 109. In this case, the automated driving execution unit 111 generates control information (control information of an acceleration/deceleration amount, a steering amount, and the like) for safely passing through the route indicated by the route information on the basis of the road surface environment information and the vehicle profile information, and controls traveling on the route indicated by the route information on the basis of the control information. Note that as described above, the information regarding the acceleration/deceleration amount is expressed by, for example, position information and vehicle speed information for passing through the position.

In addition, in step ST7, although details will be described later, update processing of the road surface environment information is repeatedly performed as the vehicle 100 travels.

Next, in step ST8, the vehicle 100 that has transmitted the remote assistance request avoids the obstacle by the automated driving in step ST7, and then in step ST9, the remote assistance processing in the remote driving system 10 ends.

In a case where it is determined in step ST3 that past route information does not exist, the remote assistance method determination unit 303 of the remote assistance server 300 transmits a remote driving operator assignment request to the remote driving controller 200 via the communication unit 301 in step ST11.

Next, in step ST12, the remote driving execution unit 107 of the vehicle 100 that has transmitted the remote assistance request performs remote driving control on the basis of the control command (an acceleration/deceleration amount, a steering amount, and the like) corresponding to the operation by the remote driving operator 600 received from the remote driving controller 200.

Further, in step ST12, although details will be described later, update processing of the road surface environment information is repeatedly performed as the vehicle 100 travels.

Next, in step ST13, the vehicle 100 that has transmitted the remote assistance request avoids the obstacle by the remote driving in step ST12, and then in step ST14, the remote assistance method determination unit 303 of the remote assistance server 300 acquires the route information of the route on which the vehicle 100 has traveled for avoiding the obstacle on the basis of the position information of the vehicle 100 that has transmitted the remote assistance request received by the vehicle information reception unit 304 and records the acquired route information in the storage unit 308.

Note that the route information recorded in the storage unit 308 is also recorded in association with summary information of the obstacle. As a result, in step ST3 described above, the remote assistance method determination unit 303 of the remote assistance server 300 can determine whether or not past route information exists in the storage unit 308 when an obstacle that can be analogized to the same obstacle as this time is avoided.

After the processing in step ST14, the remote driving system 10 ends the remote assistance processing in step ST9.

In the flowchart indicated in FIG. 11 described above, as described in step ST6, an example of the processing procedure is indicated in which the route information and the road surface environment information are transmitted from the remote assistance server 300 to the vehicle 100, and the vehicle 100 generates the control information (control information of an acceleration/deceleration amount, a steering amount, and the like) from the road surface environment information and the vehicle profile information, and performs the automated driving control on the basis of the control information. However, a processing procedure is also conceivable in which the remote assistance server 300 generates control information from the road surface environment information and the vehicle profile information, the remote assistance server 300 transmits the control information and the route information to the vehicle 100, and the vehicle 100 performs automated driving control on the basis of the control information transmitted from the remote assistance server 300.

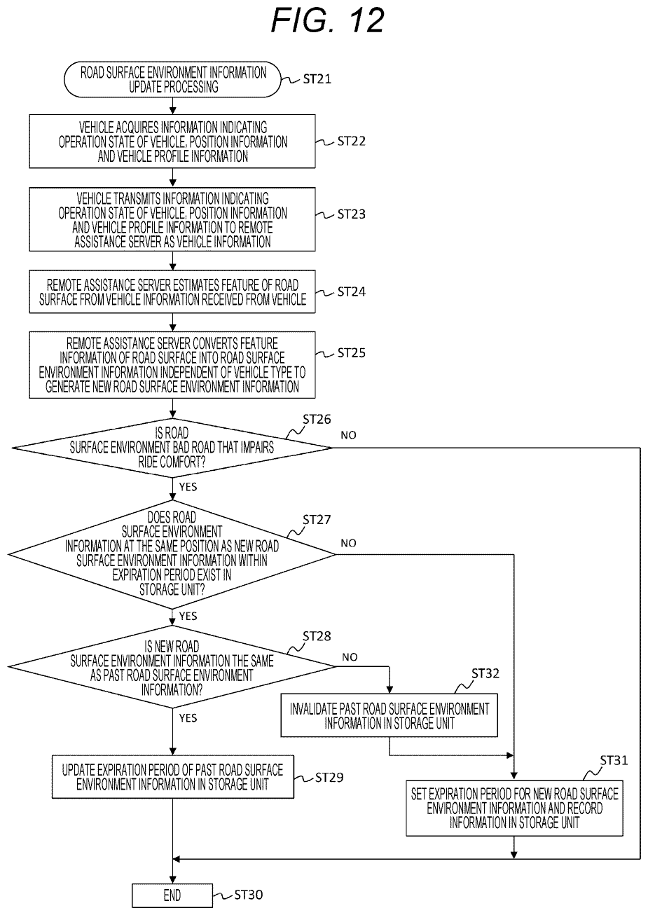

The flowchart of FIG. 12 indicates an example of a processing procedure of the above-described update processing of the road surface environment information.

In step ST21, the update processing of the road surface environment information is started. Next, in step ST22, the vehicle 100 acquires information indicating the operation state of the vehicle, the position information, and the vehicle profile information. Next, in step ST23, the vehicle 100 transmits the information indicating the operation state of the vehicle, the position information, and the vehicle profile information acquired in step ST22 to the remote assistance server 300 as the vehicle information.

Next, in step ST24, the remote assistance server 300 estimates a feature of the road surface, for example, a step, a depression, slipperiness, or the like, from the vehicle information received from the vehicle 100. Next, in step ST25, the remote assistance server 300 converts the feature information of the road surface into road surface environment information independent of the vehicle type on the basis of the vehicle profile information, and generates new road surface environment information.

Next, in step ST26, on the basis of the road surface environment information converted in step ST25, the remote assistance server 300 determines whether or not the road surface environment is a bad road that impairs ride comfort. In a case where it is determined that the road surface environment is a bad road that impairs ride comfort, in step ST27, the remote assistance server 300 determines whether or not past road surface environment information within the expiration period for the same position as the new road surface environment information generated in step ST25 exists in the storage unit 308.

In a case where it is determined that past road surface environment information within the expiration period for the same position as the new road surface environment information exists, the remote assistance server 300 determines whether or not the new road surface environment information is the same as the past road surface environment information in step ST28. In a case where it is determined that the new road surface environment information is the same as the past road surface environment information, in step ST29, the remote assistance server 300 performs update to extend the expiration period of the past road surface environment information in the storage unit 308. For example, the detection date of the road surface environment information is changed to the detection date of the new road surface environment information.

After the processing of step ST29, a series of update processing of the road surface environment information ends in step ST30.

In addition, in a case where it is determined in step ST26 that the road surface environment is not a bad road that impairs ride comfort, a series of update processing of the road surface environment information immediately ends in step ST30.

In a case where it is determined in step ST27 that past road surface environment information within the expiration period for the same position as the new road surface environment information does not exist, in step ST31, the remote assistance server 300 sets an expiration period for the new road surface environment information (see FIG. 8) and records the information in the storage unit 308. Then, after the processing of step ST31, a series of update processing of the road surface environment information ends in step ST30.

In a case where it is determined in step ST28 that the new road surface environment information is not the same as the past road surface environment information, in step ST32, the remote assistance server 300 invalidates, for example, deletes the past road surface environment information in the storage unit 308, and thereafter, in step ST31, the remote assistance server 300 sets an expiration period for the new road surface environment information and records the information in the storage unit 308. Then, after the processing of step ST31, a series of update processing of the road surface environment information ends in step ST30.

As described above, in a case where the remote assistance method determination unit 303 of the remote assistance server 300 receives the remote assistance request from the vehicle 100 that has encountered an obstacle due to which automated driving cannot be executed, the remote assistance method determination unit confirms whether or not the past route information when the vehicle 100 avoids the obstacle that can be analogized to the same obstacle as this time exists in the storage unit 308. In a case where the route information in which the obstacle that can be determined to be equivalent is avoided in the past exists, the remote assistance method determination unit determines to mechanically provide a remote assistance service. In a case where the route information does not exist, the remote assistance method determination unit determines to provide a remote driving service by the remote driving operator 600.

The processing procedure of the remote driving system 10 in a case where the remote assistance method determination unit 303 of the remote assistance server 300 determines to provide the remote driving service by the remote driving operator 600 corresponds to the processing from step ST11 to step ST14 in the flowchart of FIG. 11, and the remote assistance server 300 requests the remote driving operator assignment to the remote driving controller 200 to execute the remote driving of the vehicle 100.

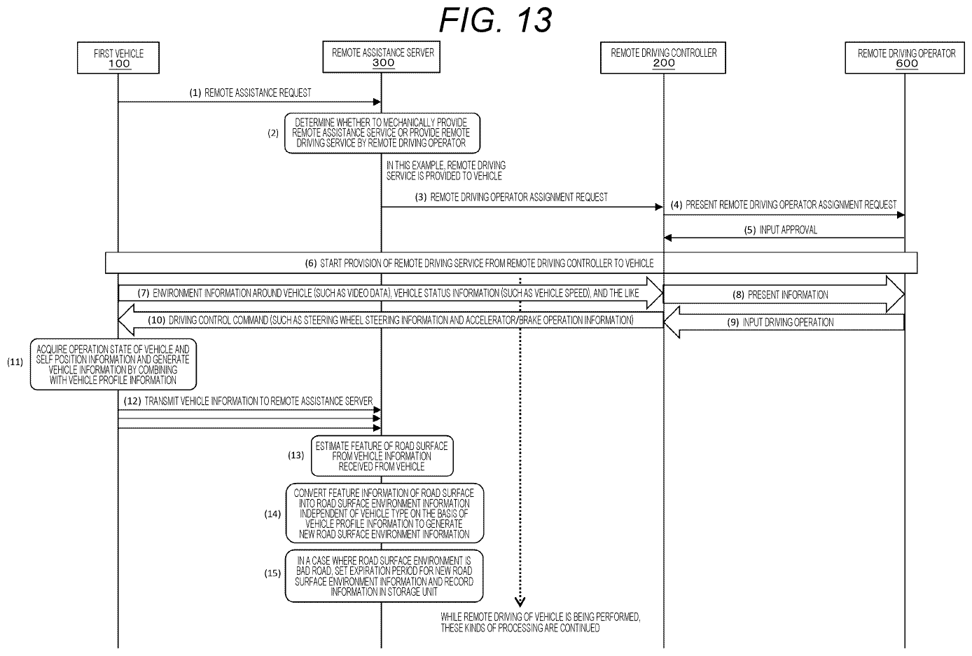

FIG. 13 indicates an example of an overall sequence of the remote assistance system 10 in that case. In the figure, the vehicle 100 in this case is indicated as a first vehicle 100.
(1) The vehicle 100 transmits a remote assistance request to the remote assistance server 300.
(2) The remote assistance server 300 determines whether to provide a remote assistance service mechanically or a remote driving service by the remote driving operator 600. In this example, the remote assistance server 300 determines to provide a remote driving service by the remote driving operator 600 to the vehicle 100. In this case, the remote assistance server 300 acquires the position information of the vehicle 100 and the environment information around the vehicle, determines that past route information does not exist in the storage unit 308 when an obstacle that can be analogized to the same obstacle as this time is avoided, and determines to provide the remote driving service by the remote driving operator 600.
(3) The remote assistance server 300 transmits a remote driving operator assignment request to the remote driving controller 200.
(4) The remote assistance controller 200 presents the remote driving operator assignment request to the remote driving operator 600 by display or speech output.
(5) The remote driving operator 600 inputs acknowledgement to the remote driving controller 200.
(6) Provision of the remote driving service from the remote driving controller 200 to the vehicle 100 is started.
(7) The environment information (such as video data) around the vehicle and the vehicle status information (such as a vehicle speed) are transmitted from the vehicle 100 to the remote driving controller 200.
(8) The remote driving controller 200 displays a video based on the video data and a status based on the status information, and presents information for remote driving of the remote driving operator 600.
(9) The remote driving operator 600 inputs driving operation to the remote driving controller 200 by operating a steering wheel, a brake pedal, an accelerator pedal, and the like.
(10) The remote driving controller 200 transmits a driving control command (steering wheel steering information, accelerator/brake operation information, and the like) to the vehicle 100. As a result, the remote driving is executed in the vehicle 100 that has requested remote assistance.
(11) The vehicle 100 acquires the operation state and the position information of the vehicle, and generates the vehicle information together with the vehicle profile information.
(12) The vehicle 100 periodically generates the vehicle information and repeatedly transmits the vehicle information to the remote assistance server 300.
(13) The remote assistance server 300 estimates a feature of the road surface, for example, a step, a depression, slipperiness, and the like, from the vehicle information received from the vehicle 100.
(14) The remote assistance server 300 converts the feature information of the road surface into road surface environment information independent of the vehicle type on the basis of the vehicle profile information, and generates new road surface environment information.
(15) In a case where it is determined that the road surface environment is a bad road, the remote assistance server 300 sets an expiration period for the new road surface environment information and stores the information in the storage unit 308.

While the vehicle 100 is being remotely driven, the processing from (7) to (15) described above is continued. Note that although not illustrated, the remote driving ends after the vehicle 100 avoids the obstacle, and thereafter, the remote assistance server 300 stores the route information of the route on which the vehicle 100 has traveled in the storage unit 308.

The processing procedure of the remote driving system 10 in a case where the remote assistance method determination unit 303 of the remote assistance server 300 determines to mechanically provide the remote assistance service corresponds to the processing from step ST4 to step ST8 in the flowchart of FIG. 11, and the remote assistance server 300 transmits the route information and the road surface environment information as the driving assistance information to the vehicle 100 and causes the vehicle 100 to execute the automated driving.

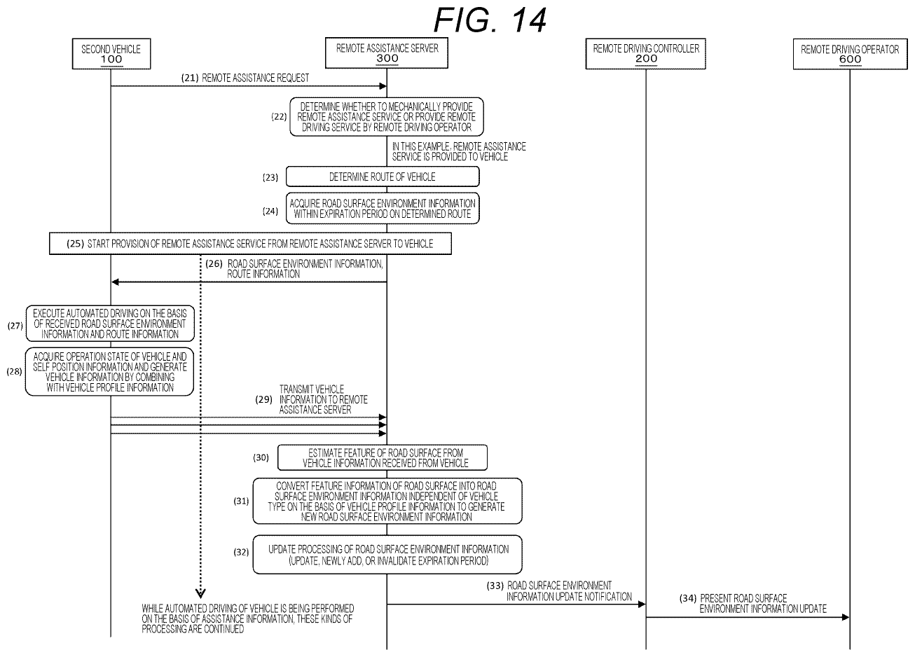

FIG. 14 indicates an example of an overall sequence of the remote assistance system 10 in that case. In the figure, the vehicle 100 in this case is indicated as a second vehicle 100.
(21) The vehicle 100 transmits the remote assistance request to the remote assistance server 300.
(22) The remote assistance server 300 determines whether to provide a remote assistance service mechanically or a remote driving service by the remote driving operator 600. In this example, the remote assistance server 300 determines to mechanically provide a remote assistance service to the vehicle 100. In this case, the remote assistance server 300 acquires the position information of the vehicle 100 and the environment information around the vehicle, determines that past route information when the vehicle 100 avoids an obstacle that can be analogized to the same obstacle as this time exists in the storage unit 308, and determines to mechanically provide a remote assistance service to the vehicle 100.
(23) The remote assistance server 300 calculates and determines the route of the vehicle 100 that has transmitted the remote assistance request on the basis of the past route information.
(24) The remote assistance server 300 searches the storage unit 308 to acquire the road surface environment information within the expiration period on the determined route. In this case, the road surface environment information within the expiration period on the determined route does not necessarily exist in the storage unit 308, and may not exist. In the following description, it is assumed that the road surface environment information within the expiration period on the determined route exists in the storage unit 308.
(25) Provision of the remote assistance service from the remote assistance server 300 to the vehicle 100 is started.
(26) The remote assistance server 300 transmits the road surface environment information and the route information to the vehicle 100 as remote assistance information.
(27) The vehicle 100 performs automated driving on the basis of the received route information and road surface environment information.
(28) The vehicle 100 acquires the operation state and the position information of the vehicle, and generates the vehicle information together with the vehicle profile information.
(29) The vehicle 100 periodically generates the vehicle information and repeatedly transmits the vehicle information to the remote assistance server 300.
(30) The remote assistance server 300 estimates a feature of the road surface, for example, a step, a depression, slipperiness, and the like, from the vehicle information received from the vehicle 100.
(31) The remote assistance server 300 converts the feature information of the road surface into road surface environment information independent of the vehicle type on the basis of the vehicle profile information, and generates new road surface environment information.
(32) The remote assistance server 300 performs update processing of the road surface environment information in the storage unit 308, that is, update, new addition, invalidation, and the like, of the expiration period. In this case, in a case where the road surface environment is a bad road and road surface environment information within the expiration period for the same position as the new road surface environment information does not exist in the storage unit 308, the expiration period is set for the new road surface environment information and recorded in the storage unit 308. In addition, in a case where the road surface environment is a bad road, road surface environment information within the expiration period for the same position as the new road surface environment information exists in the storage unit 308, and the new road surface environment information is the same as the past road surface environment information, the expiration period of the past road surface environment information in the storage unit 308 is updated. In addition, in a case where the road surface environment is a bad road, road surface environment information for the same position as the new road surface environment information within the expiration period exists in the storage unit 308, and the new road surface environment information is not the same as the past road surface environment information, the past road surface environment information in the storage unit 308 is invalidated, and the expiration period is set for the new road surface environment information and recorded in the storage unit 308.
(33) In a case where the update processing of the road surface environment information in the storage unit 308 is performed, the remote assistance server 300 transmits a road surface environment information update notification to the remote driving controller 200.
(34) The remote assistance controller 200 presents the update of the road surface environment information in the storage unit 308 to the remote driving operator 600 by display or speech output.

Note that, although omitted in the illustrated example, in a case where the vehicle 100 is performing automated driving on the basis of the road surface environment information and the route information transmitted from the remote assistance server 300, environment information (such as video data) around the vehicle and vehicle status information (such as a vehicle speed) may be transmitted from the vehicle 100 to the remote driving controller 200, and the remote driving controller 200 may display a video based on the video data and a status based on the status information. In this case, in a case where the update of the road surface environment information is presented as described above, the remote driving operator 600 can also check whether or not the update is appropriate from the display of the video and the status.

While the vehicle 100 is performing automated driving on the basis of the assistance information (the route information and the road surface environment information), the processing from (26) to (34) described above is continued.

As described above, in the remote driving system 10 illustrated in FIG. 1, by using the road surface environment information acquired from the vehicle 100 that has passed through the same obstacle in the past, it is possible to mechanically provide the remote assistance service to the vehicle 100 that newly needs driving assistance for the same obstacle without impairing ride comfort, and to reduce the load on the remote driving operator 600.

### 2. Modifications

Note that, in the above-described embodiment, the description has been given assuming that the first vehicle 100 is remotely driven in a case where the first vehicle 100 encounters an obstacle due to which automated driving cannot be performed, but the present technology is not limited thereto. For example, the vehicle may be driven by a driver on a driver's seat of the first vehicle 100, or may be automatically driven by some means.

Further, in the above embodiment, the remote driving controller 200 is also connected to the communication network 500 similarly to the remote assistance server 300, but the remote driving controller 200 may be connected to the communication network 500 via the remote assistance server 300. The remote driving controller 200 and the remote assistance server 300 may be integrally configured.

Furthermore, although the preferred embodiment of the present disclosure has been described above in detail with reference to the accompanying drawings, the technical scope of the present disclosure is not limited to such an example. It is apparent that a person having ordinary knowledge in the technical field of the present disclosure can achieve various type of examples of changes or modifications within the scope of the technical idea recited in the claims, and it will be naturally understood that such examples also belong to the technical scope of the present disclosure.

Furthermore, the effects described in the present specification are merely exemplary or illustrative, and not restrictive. In other words, the technology according to the present disclosure can exhibit other effects apparent to those skilled in the art from the description of the present specification, in addition to the effects described above or instead of the effects described above.

In addition, the present technology can also have the following configurations.
(1) An information processing apparatus including:
   a road surface environment information generation unit that generates road surface environment information on a road surface of a predetermined route on the basis of a vehicle operation state when a first vehicle travels on the predetermined route; and
   a control information generation unit that generates control information when a second vehicle travels on the predetermined route on the basis of the road surface environment information.
(2) The information processing apparatus according to (1), in which
   the predetermined route is a route on which the first vehicle travels to avoid a predetermined obstacle.
(3) The information processing apparatus according to (2), in which
   the predetermined obstacle exists on the predetermined route.
(4) The information processing apparatus according to (2), in which
   the predetermined obstacle exists on a route different from the predetermined route, and
   the predetermined route is a route for bypassing the route different from the predetermined route.
(5) The information processing apparatus according to any one of (1) to (4), further including:
   a storage unit that records the road surface environment information generated by the road surface environment information generation unit in association with position information and expiration period information.
(6) The information processing apparatus according to (5), in which
   the control information generation unit selectively uses
   the road surface environment information corresponding to the predetermined route on the basis of the position information.
(7) The information processing apparatus according to (5) or (6), in which
   the control information generation unit selectively uses the road surface environment information within an expiration period on the basis of the expiration period information.
(8) The information processing apparatus according to any one of (5) to (7), further including:
   a road surface environment information update unit that generates road surface environment information on the basis of vehicle operation information when the second vehicle travels on the predetermined route and updates the road surface environment information recorded in the storage unit.
(9) The information processing apparatus according to (8), in which
   the road surface environment information update unit records the generated road surface environment information in the storage unit when the road surface environment information for the same position as the generated road surface environment information is not recorded in the storage unit.
(10) The information processing apparatus according to (8) or (9), in which
   the road surface environment information update unit extends an expiration period of the recorded road surface environment information when the road surface environment information having the same content for the same position as the generated road surface environment information is recorded in the storage unit.
(11) The information processing apparatus according to any one of (8) to (10), in which
   the road surface environment information update unit deletes the recorded road surface environment information from the storage unit and records the generated road surface environment information in the storage unit when road surface environment information having different content for the same position as the generated road surface environment information is recorded in the storage unit.
(12) The information processing apparatus according to any one of (8) to (11), further including:
   a road surface environment information update notification unit that, when the road surface environment information recorded in the storage unit is updated by the road surface environment information update unit, notifies a remote driving operator of the update.
(13) An information processing method including:
   a procedure of generating road surface environment information on a road surface of a predetermined route on the basis of a vehicle operation state when a first vehicle travels on the predetermined route; and
   a procedure of generating control information when a second vehicle travels on the predetermined route on the basis of the road surface environment information.
(14) An information processing system including:
   a first vehicle;
   a remote assistance server; and
   a second vehicle, in which
   the first vehicle transmits vehicle operation information when the first vehicle travels on a predetermined route to the remote assistance server,
   the remote assistance server generates road surface environment information on a road surface of the predetermined route on the basis of the vehicle operation information transmitted from the first vehicle, and transmits the generated road surface environment information or control information generated on the basis of the road surface environment information to the second vehicle traveling on the predetermined route, and
   the second vehicle performs automated driving control on the basis of control information generated on the basis of the road surface environment information transmitted from the remote assistance server or the control information transmitted from the remote assistance server.
(15) The information processing system according to (14), in which
   the first vehicle travels on the predetermined route on the basis of operation by a remote driving operator.
(16) The information processing system according to (14) or (15), in which
   the predetermined route is a route on which the first vehicle travels to avoid a predetermined obstacle.
(17) The information processing system according to (16), in which
   the predetermined obstacle exists on the predetermined route.
(18) The information processing system according to (16), in which
   the predetermined obstacle exists on a route different from the predetermined route, and
   the predetermined route is a route for bypassing the route different from the predetermined route.
(19) A driving assistance server including:
   a reception unit that receives a vehicle operation state when a first vehicle travels on a predetermined route from the first vehicle;
   a generation unit that generates road surface environment information on a road surface of the predetermined route on the basis of the vehicle operation state; and
   a transmission unit that transmits the road surface environment information or control information generated on the basis of the road surface environment information to a second vehicle traveling on the predetermined route.
(20) The driving assistance server according to 19, further including:
a storage unit that records the road surface environment information generated by the generation unit in association with position information and expiration period information.

### REFERENCE SIGNS LIST

10 Remote driving system
100 Vehicle
101 Driving/braking device
102 Steering device
103 Various external sensors
104 Various internal sensors
105 Vehicle profile information holding unit
106 Communication unit
107 Remote driving execution unit
108 Vehicle information acquisition/transmission unit
109 Driving assistance information reception unit
110 Remote assistance request transmission unit
111 Automated driving execution unit
112 Map information holding unit
200 Remote driving controller
201 Brake pedal
202 Accelerator pedal
203 Steering wheel
204 Video display device
205 Status display area
206 Speaker
211 Input unit
212 Output unit
213 Communication unit
300 Remote assistance server
301 Communication unit
302 Remote assistance request reception unit
303 Remote assistance method determination unit
304 Vehicle information reception unit
305 Road surface environment estimation unit
306 Road surface environment information management unit
307 Driving assistance information transmission unit
400 Wireless base station
500 Communication network
600 Remote driving operator

What is claimed is:

1. An information processing apparatus comprising:
a road surface environment information generation unit that generates road surface environment information on a road surface of a predetermined route on a basis of a vehicle operation state when a first vehicle travels on the predetermined route; and
a control information generation unit that generates control information when a second vehicle travels on the predetermined route on a basis of the road surface environment information.

2. The information processing apparatus according to claim 1, wherein
the predetermined route is a route on which the first vehicle travels when the first vehicle avoids a predetermined obstacle.

3. The information processing apparatus according to claim 2, wherein
the predetermined obstacle exists on the predetermined route.

4. The information processing apparatus according to claim 2, wherein
the predetermined obstacle exists on a route different from the predetermined route, and
the predetermined route is a route for bypassing the route different from the predetermined route.

5. The information processing apparatus according to claim 1, further comprising:
a storage unit that records the road surface environment information generated by the road surface environment information generation unit in association with position information and expiration period information.

6. The information processing apparatus according to claim 5, wherein
the control information generation unit selectively uses the road surface environment information corresponding to the predetermined route on a basis of the position information.

7. The information processing apparatus according to claim 5, wherein
the control information generation unit selectively uses the road surface environment information within an expiration period on a basis of the expiration period information.

8. The information processing apparatus according to claim 5, further comprising:
a road surface environment information update unit that generates road surface environment information on a basis of vehicle operation information when the second vehicle travels on the predetermined route and updates the road surface environment information recorded in the storage unit.

9. The information processing apparatus according to claim 8, wherein
the road surface environment information update unit records the generated road surface environment information in the storage unit when the road surface environment information for the same position as the generated road surface environment information is not recorded in the storage unit.

10. The information processing apparatus according to claim 8, wherein
the road surface environment information update unit extends an expiration period of the recorded road surface environment information when the road surface environment information having the same content for the same position as the generated road surface environment information is recorded in the storage unit.

11. The information processing apparatus according to claim 8, wherein
the road surface environment information update unit deletes the recorded road surface environment information from the storage unit and records the generated road surface environment information in the storage unit when road surface environment information having different content for the same position as the generated road surface environment information is recorded in the storage unit.

12. The information processing apparatus according to claim 8, further comprising:
a road surface environment information update notification unit that, when the road surface environment information recorded in the storage unit is updated by the road surface environment information update unit, notifies a remote driving operator of the update.

13. An information processing method comprising:
a procedure of generating road surface environment information on a road surface of a predetermined route on a basis of a vehicle operation state when a first vehicle travels on the predetermined route; and
a procedure of generating control information when a second vehicle travels on the predetermined route on a basis of the road surface environment information.

14. An information processing system comprising:
a first vehicle;
a remote assistance server; and
a second vehicle, wherein
the first vehicle transmits vehicle operation information when the first vehicle travels on a predetermined route to the remote assistance server,
the remote assistance server generates road surface environment information on a road surface of the predetermined route on a basis of the vehicle operation information transmitted from the first vehicle, and transmits the generated road surface environment information or control information generated on a basis of the road surface environment information to the second vehicle traveling on the predetermined route, and
the second vehicle performs automated driving control on a basis of control information generated on a basis of the road surface environment information transmitted from the remote assistance server or the control information transmitted from the remote assistance server.

15. The information processing system according to claim 14, wherein
the first vehicle travels on the predetermined route on a basis of operation by a remote driving operator.

16. The information processing system according to claim 14, wherein
the predetermined route is a route on which the first vehicle travels when the first vehicle avoids a predetermined obstacle.

17. The information processing system according to claim 16, wherein
the predetermined obstacle exists on the predetermined route.

18. The information processing system according to claim 16, wherein
the predetermined obstacle exists on a route different from the predetermined route, and
the predetermined route is a route for bypassing the route different from the predetermined route.

19. A driving assistance server comprising:
a reception unit that receives a vehicle operation state when a first vehicle travels on a predetermined route from the first vehicle;
a generation unit that generates road surface environment information on a road surface of the predetermined route on a basis of the vehicle operation state; and
a transmission unit that transmits the road surface environment information or control information generated on a basis of the road surface environment information to a second vehicle traveling on the predetermined route.

20. The driving assistance server according to claim 19, further comprising:
a storage unit that records the road surface environment information generated by the generation unit in association with position information and expiration period information.
